(19) United States
(12) Patent Application Publication
(10) Pub. No.: US 2007/0023194 A1
(43) Pub. Date: Feb. 1, 2007

(54) Methods and compositions for cementing shoes on hoofed animals and for hoof repair

(76) Inventor: Stewart J. Lustgarten, Palm Beach Gardens, FL (US)

Correspondence Address: EDWARDS & ANGELL, LLP, P.O. BOX 55874, BOSTON, MA, 02205, US

(21) Appl. No.: 11/495,194

(22) Filed: Jul. 28, 2006

Related U.S. Application Data
(60) Provisional application No. 60/702,850, filed on Jul. 28, 2005.

(51) Int. Cl. A01L 3/00

(52) U.S. Cl. 168/4

(57) ABSTRACT

Methods and kits are described for shoeing a hoofed animal. First, an acid conditioner is applied to a hoof for a time sufficient to etch and further expose the inner epidermis layer of the hoof. Then, a bonding resin is applied to the hoof. After drying or polymerization, a cement composition is applied to the area of the hoof where a shoe will be placed. Finally, a shoe is positioned in the cement composition and permitted to set, thereby affixing the shoe to the hoof.

### CROSS-REFERENCE TO RELATED APPLICATIONS

This application claims priority from U.S. Provisional Application Ser. No. 60/702,850 filed Jul. 28, 2005, the disclosure of which is hereby incorporated by reference.

### BACKGROUND OF THE INVENTION

1. Field of the Invention

This invention(s) relates to a composition and method for affixing horseshoes to a horse's hoof and for hoof repairs and restoration on various other hoofed animals.

2. Description of Related Art Including Information Disclosed Under 37 C.F.R. §§ 1.97-1.98

Currently, the age old and most popular method to affix any kind of horseshoe is by nailing into the hard outer horn tissue of the hoof using suitable nails. However, the hoof is exposed to a variety of adverse conditions, subject to which nailing may weaken the hard horn and create various micro-cracks and loosening and may propagate and support various fungal and bacterial maladies, also making the nailing procedure difficult.

Further, current methods using metal horseshoes do not have any impact absorption and stress distribution. A variety of wear resistant plastic shoes have recently been designed and developed to cushion these high impact forces and better distribute them within the hoof when meeting the ground. Current methods of affixing the plastic shoes employ nailing and cementation with conventional cements, which only provide adhesive properties at the cement/horn tissue interface.

The hoof is comprised of inner dermis layers and three (3) outer epidermis layers. The coronary regenerative layer of the dermis continuously gives rise to new epidermis layers, which include the outer horn or external stratum, medium stratum and stratum internum or stratum laminae. At periodic intervals of 4 to 6 weeks, old horseshoes are removed. The hoof is trimmed to accommodate for new growth, which growth is more so at the toe rather than the heel. Thus, the hoof is prepared for new shoes while compensating for the change of contact angle to the ground from this new uneven growth. During this trimming and preparation some of the outer horn epidermis layer is removed. Typically, then, the shoe is nailed to the prepared hoof.

U.S. Pat. No. 6,732,807 B2 discloses improvement in the union of a plastic horseshoe and the hoof with a bonding agent such as a two part adhesive, for example, a urethane polymer. The disclosure states that the bonding agent can be applied to the flange portion of the plastic shoe after which the horse should be encouraged to stand as still as possible for about 10 to 15 minutes until the bonding agent has hardened.

U.S. Pat. No. 6,843,323 B2 discloses the use of a two-part methacrylate adhesive comprising not more than 55% by weight methyl methacrylate and not more than 8% by weight methacrylic acid for a bonding agent for plastic shoes.

New and better methods for affixing shoes, particularly to animals having damage to the hoof would be beneficial.

### SUMMARY OF THE INVENTION

The present invention provides methods and compositions for affixing a shoe to a hoofed animal without the necessity for use of nails. Thus, the present invention provides a method for shoeing a hoofed animal, the method comprising: applying an acid conditioner to a hoof for a time sufficient to etch and further expose the inner epidermis layer of the hoof; applying a bonding resin to the hoof; applying a cement composition to the area of the hoof where a shoe will be placed; positioning the shoe in the cement composition; and permitting the cement composition to set, thereby affixing the shoe to the hoof.

In preferred embodiments, when ready for re-shoeing, the hoof is trimmed first in a conventional manner to provide an even surface for the shoe. After the conventional trimming, a mild acid conditioner is applied to the hoof to etch and further expose the inner epidermis layer of the hoof, which comprises hollow tubules and a network of fibrous keratanized intertubular and peritubular horn tissue. The bonding resin comprising a polymerizable resin is then applied to the shoe bearing surface of the hoof. After the bonding agent dries, or is self-cured or command set (i.e., photo-polymerized), a self-curing or photo-polymerized cement composition is applied to the hoof area to be shoed and the shoe is positioned in the cement composition. Finally, the cement composition is set, thereby, forming a firm adhesive and mechanical retentive bond at the shoe and hoof interface. In the alternative, the cement composition also can contain a photo sensitive activator and catalyst which will command polymerize upon exposure to a irradiation such as, e.g., a visible curing light.

Surprisingly, the use of acid etching prior to use of the adhesive resin promotes a longer lasting adhesive and mechanical retentive bond at the shoe and hoof interface. Thus, a plastic or a metal shoe can be affixed adhesively, molecularly and mechanically to the animal hoof without the use of nails. In certain preferred embodiments of the invention, ferric chloride is added to the acid during the etching step.

This invention takes advantage of multi-functional retention of the cement to the hoof, which is afforded by the hoof anatomy and morphology. During trimming and preparation of the hoof for re-shoeing, some of the outer horn epidermis layer is removed exposing the stratum medium layer which, in accord with this invention, is far more suitable for adhesive and mechanical retentive cementation of the shoe to the hoof. The inner epidermis layer from the external stratum layer is richly comprised of hollow tubules and a network of fibrous keratanized intertubular and peritubular horn tissue. The invention takes advantage of these hollow tubules and the exposed surface fibrils of the keratanized peritubular and intertubular horn tissue to achieve mechanical retention by resin and to form hard and retentive resin tags once polymerized within the tubule itself. The peritubular walls are those internal walls within each tubule. The interbular collagen tissue is that tissue lying between tubules. Upon surface preparation, removal of possible collagenous plugs can be obtained with a mild ferric chloride containing acid. The plugs may block entry into the tubules and may be a result of trimming and filing. This acid treatment with optional use of ferric chloride opens these tubules to expose the peritubular and interbular collagen fibrils. Thus, the polymerizable resin such as, for example, a hydrophilic acrylate or other suitable unfilled or organically and/or inorganically filled resin, when applied to the shoe bearing surface of the hoof, can interpenetrate the hollow tubules and fibrils. Once hardened, the resin attaches to the tubules and fibrils to form a firm and longer lasting adhesive and mechanical retentive bond at the critical shoe and hoof interface.

In a preferred embodiment of the invention, the method involves applying a conditioner composition comprising a mild acid, ferric chloride followed by application of a bonding resin and, finally, a layer of a cement comprising a polymerizable resin to a hoof, positioning the shoe on the layer and, then, polymerizing the resins to affix the shoe to the hoof.

In another preferred embodiment of the invention, the conditioner and the bonding agent are combined and applied in a single step. Preferably, the bonding agent is a polymerizable monomer or oligomer that will molecularly chelate to the denatured proteins in the hoof tissue.

The invention also provides a method for hoof repair. The method comprises applying an acid conditioner to a hoof for a time sufficient to etch and further expose the inner epidermis layer of the hoof; applying a bonding resin to the hoof, and applying a cement composition to the area of the hoof to be repaired.

### DETAILED DESCRIPTION OF THE INVENTION INCLUDING PREFERRED EMBODIMENTS

In one embodiment, the present invention provides a multi-step application to an animal hoof of conditioner, a bonding resin and a cement, which attaches a metal or plastic shoe to the hoof. As aforesaid, the conditioner and bonding resin may be applied in a single step. Preferably, the shoe is provided with mechanical retention means such as dove tailed nail holes, weight reducing holes, or other structural features to engage with the cement to permit mechanical retention.

The conditioner is selected from a mild acid from a group of organic acids including, for example, ethylenediaminetetraacetic acid (“EDTA”), malic acid, malaeic acid, glutaric dialdehyde or a low to medium concentration of inorganic acids such as citric acid, acetic acid, phosphoric acid, nitric acid or sulfuric acid, or mixtures thereof. The acid conditioner should be strong enough to etch the hoof tissue, but should not damage the tissue. This can be accomplished by balancing the strength of the acid and time of application. The acid is then washed off with copious amounts of water. The acid etch should enhance the morphology of the hoof and permit clear visualization of the tubules, but should not allow gross tissue damage or gross pitting of the tissue. The epidermal layer of the hoof, after etching, should appear clean without noticeable tissue damage from the conditioner. The application of this acid has been shown to remove any smeared layer tubular plugs and slightly etches the intertubular and peritubular horn tissue to expose strands of collagenous fibrils. Typically, an aqueous solution having an acid concentration of 35 to 50% provides suitable results in a few minutes preferably in about one (1) minute.

In certain embodiments of the invention, it is preferred that the conditioner also contain a small percentage of ferric chloride. When, ferric chloride is used, the fibrils appear to stand upright.

Upon this conditioner prepared surface, a bonding resin is coated. The bonding resin is a first resin layer which comprises a polymerizable or self-drying and hardening, fibril-interpenetrating coating of a unfilled or slightly filled bonding resin including acrylate, dimethacrylate, cyanoacrylate, urethane, epoxy, silicone, or the like, etc. Preferably, the resin contains a hydrophilic polymerizable resin composition containing hydroxyethylmethacrylate (“HEMA”), which provides a more hydrophilic, wettable and spreadable layer for improved adhesion to the hoof. When HEMA is used for the bonding agent, i.e., the first resin layer, preferably, glutaric dialdehyde is mixed with the HEMA to accomplish acid etching and denaturing the collagen protein while providing molecular chelation to the denatured protein and application of the bonding agent in one step.

The bonding agent can be dried onto the hoof when a compatible cement composition is used. In such event, the bonding agent will polymerize when the cement composition polymerizes. Alternatively, the bonding agent can self polymerize, or be photo-polymerized initiated (i.e., command set), or can be capable of dual curing (either self-polymerizing or command set at the discretion of the user).

Upon completion of this step, a cement composition comprising suitable second resin matrix of an organically or inorganically filled two-part chemically curable polymer, or photopolymerizably curable polymer, or a combination of both known as a dual curing, or a self-hardening or drying cement, is then applied to the hoof bearing surface for placement of the plastic or metal shoe. The shoe is set into this cement layer and any compensation for shoe adjustment is made prior and during the working time for the mixed materials to initiate polymerization, hardening or drying, or prior to command set.

A preferred cement composition contains organic or inorganic fillers, either silane treated or silane untreated, including but not limited to, silica, fumed silica, diatomaceous earth, ground glass, zeolite, aluminosilicate and/or fractionated organic polymer particles derived from a polymer containing a methacrylic acid monomer. The polymer preferably comprises a methyl, ethyl, hydroxyethyl, propyl or butyl methacrylates, and mixtures thereof. The filler is added to the polymerizable resin, preferably in an amount by weight of from about 10% to about 60% of the total mixture to a desired viscosity.

Applicant has discovered that certain dental filler materials are useful as the cement composition in the practice of the present invention. Thus, the resin for the second layer preferably comprises materials as described in U.S. Pat. No. 4,412,015, which is hereby incorporated by reference. The cement composition is formed preferably using the filler material and a methacrylate based polymeric resin binder system. A cement composition with particularly advantageous properties can be formed by employing an inorganic filler material comprising finely divided particles of silica or silicate glass, preferably barium containing glass and/or zeolite crystals of predetermined size with up to 100% of such particles provided with a coating of a polymerized acrylate containing monomers or oligomers.

The cement compositions obtained by using the mineral inorganic filler particles, in particular, has the advantage that before hardening they have a non-sticky consistency and therefore can be easily formed. They also are distinguished by an excellent polishing quality, increased abrasion resistance and hardness, a low thermal expansion coefficient and by low polymerization shrinkage. Moreover, the cement composition displays good packing and tamping capability to make shoe adjustments. The enhanced properties of these cement compositions also can be used for hoof repair following the same application steps as used in shoeing, except omitting the shoe.

The inorganic filler particles useful for these cement compositions can be selected of any conventional silica or silicate glass or mineral composition but is preferably a barium containing glass or a zeolite crystal or a combination thereof. The zeolite crystal is preferably an aluminosilicate with a stero lattice structure although any variety of zeolite containing aluminum and one of more other metallic elements particularly sodium, potassium or calcium may be used. The zeolite structure although preferably crystalline may also be amorphous. The barium containing glass can be prepared by melting together, at a minimum temperature (1100°-1300° C.) and for a minimum time (about 1 hour) necessary to obtain a homogeneous molten glass with the following glass making ingredients:

SiO₂—44 parts in mol percent

BaF₂—28 parts in mol percent

Al₂O₃—12 parts in mol percent

B_{2 O}₃—16 parts in mol percent

The glass can be melted, quenched and finely ground by means well known to the glass making art.

The inorganic filler particles should preferably have a Mohs hardness of no more than about 7 and preferably between 3 to 5 and should have a mean particle size of between about 0.01 to about 20 microns and preferably between about 1-5 microns. The selected inorganic filler particles preferably should be enclosed within a synthetic covering of a polymeric based resin which has been heat, cold or light polymerized, preferably an acrylic resin. The synthetic material coating of the filler particles preferably possesses a mean thickness range from that of a thin film up to a thickness of 35 microns but is preferably between 1-3 microns in thickness. The thickness is advantageously selected in a manner such that the mean diameter of the coated particles lies between about 0.1 and about 50 microns although more preferably between about 1 to 10 microns.

The composition of the coating surrounding the filler particles can be selected without consideration of subsequent processing conditions. Thus, for instance, a material or hardening procedure may be selected to provide a particularly great strength and adhesion properties between the coating and the mineral filler particles or to achieve a particularly great hardness or other properties in the coating. By proper selection of coating material hardness, a stepwise hardness transition from the mineral filler particles to the matrix can be obtained and, thus, particularly good properties for the composite may be realized.

Any hardenable synthetic material known to the art may be used to coat the filler particles. It is considered to be advantageous and preferred to use a synthetic material compatible with the resin binder in the cement composition. The resin binder preferably can be any standard acrylic based polymeric binder such as, for example, a polymeric binder used for preparing dental composites, containing monomers or oligomers. A particularly preferred monomer or oligomer for use in formulating the resin binder matrix of the cement composition and for use as the filler particle coating material is triethyleneglycol dimethacrylate.

It is also advantageous to use a silane coupling agent such as, for example, methacryloxypropyltrimethoxysilane to promote adhesion between the binder and the filler material in a manner as fully disclosed in the prior art.

It should be understood that also contemplates the use of a combination of conventional particles of filler mixed with polymerized coated particles of inorganic filler in mixing ratios of 1:10 to 10:1 by weight and in particular a ratio of 1:1.

The preparation of the mineral particles can be carried out by treating the selected filler material after the material is properly sized with a solution containing the preferred monomer or oligomer in a suitable organic solvent. For example, the particles may be treated with a solution of triethyleneglycol dimethacrylate in methylene chloride (“CH₂Cl₂”). The mixture is evaporated after treatment with the precipitated monomer heat polymerized. The resulting mixture can be milled and then sifted into an appropriate particle size range of preferably between 1 to 10 microns. In following this procedure agglomeration of the particles into a mass may be unavoidable, requiring the added step of milling the agglomerated mass of particles into the desired size range. This agglomeration may be avoided if the polymerization takes place in a liquid phase such as in the formation of pearl polymeride within the dispersion or when the polymerization occurs in a fluid bed, i.e., in a gaseous phase.

The coated filler particles in combination with, or exclusive of, uncoated filler particles can then be added in a conventional manner to form the major component, usually constituting at least 60 percent by weight, of a cement composition for adhering a shoe to an animal hoof. The uncoated particles are preferably treated with or a silane keying agent to promote adhesion and to render the particles hydrophobic. The cement composition can be packaged in a paste-paste or paste-liquid system suited for use, as is well known to those skilled in the art. It should also be understood that the cement composition may be packaged as a single paste system incorporating one or more conventional light initiators for effecting polymerization under ultraviolet or visible light. An advantage for the consistency of the paste and the improved formability of the paste is a controlled variable depending upon the percentage of coated inorganic filler and particle size distribution.

A preferred cement composition is a co-polymeric mixture of urethane dimethacrylate (UDMA), hydroxyethylmethacrylate (HEMA), heaxanedioldimethacrylate (HDDMA) and polymerization and photopolymerization initiators and selected from catalysts such as diethylaminomethyl methacrylate (DEAMA), N,N-dimethyl-para-toluidine (DPT), benzoyl peroxide (BPO) and camphorquinone (CQ). The organic fillers and/or the inorganic fillers are added to the polymerizable or self-hardening or drying resin to form a suitable cream-like or paste-like and non-runny consistency, preferably, a non-Newtonian thixotropic fluid having properties for cementation, preferably having a weight ratio of 10 to 60 percent filler and, further, preferably the filler particles are treated with a silane coupling agent or are coated with a polymerized layer of oligomers to promote filler adhesion to the cement resin matrix.

These fast setting polymer cement compositions and methods can also be used to fill in missing aspects of hoof and cracks and restoration of other sorts of hoof anomalies. A more cushioned composition can be made when a plasticizing agent such as dibutyl phthalate (DBP) or dioctyl phthalate (DOP) in a range of 10% to 35% by weight is added to the organic resin component portion of the above compositions.

The invention can utilize both metal and molded thermoset and thermoplastic shoes of various sizes, preferably horseshoes. Although the horseshoe can be made of any high impact resistant thermoset or thermoplastic polymer, a preferred material is polycaprolactone, which is a biodegradable, low melt thermoplastic with many of the same high impact, scuff and wear resistant properties of polyethylene. Hot water, steam, heat gun and infra-red light can be easily used by the farrier to soften this low melt plastic to fabricate a horseshoe for closer adaptation and fitting to each individual horses hoof's own characteristics, shape and size in a very similar manner of how metal horseshoes are now fitted.

The present invention provides a revolutionary new polymer cement system for shoeing hoofed animals that can provide a multi-functional and moisture resistant bonding to the hoof cellular tissue rather than just simple adhesive bonding alone. Preferred cements are significantly more moisture resistant, the hoof/cement bonded interface is considerably stronger and preferably provides very high tenacity due to a low surface tension of the adhesive and molecular and mechanical retention to the collagen-rich epidermal tissue of the hoof.

Metal and plastic shoes have been reported to be securely retained even under the most adverse conditions for periods exceeding 14 weeks.

When used for hoof fill-ins of cracks, splits, voids and missing hoof aspect restoration, preferred embodiments uniquely provide an integral bond to the hoof epidermal tissue, which prevents micro-leakage (which can cause infection and/or re-current infection), while providing the security of longer lasting, trouble-free service for the shoed hoof. Preferred cement compositions, as described above, can provide affinity, compatibility and much greater strength of bond to the hoof, which is actually stronger than the hoof epidermal tissue itself.

An embodiment of a basic cement system is a 3-component system of an easily applied hoof conditioner (acid etch), a bonding assist resin and fast setting cement resin. The cement resin preferably is a non-runny, thixotropic two-component paste and preferably has a work time of about 1½ minutes and fully sets in 1 minute, thereafter, at room temperature. Further, extreme cold or heat will not adversely affect these work and setting times of preferred embodiments. The components can be conveniently packaged, for example, in 50 ml, 180 ml, etc. self-mix cartridges with mixing tips or in a similar and convenient saddle bag auto-mix 3 pack of 10 ml push type syringes with mix tips sufficient for hoof field repair or for shoeing in the field.

To shoe a horse's hoof in accord with the present invention, it is recommended to use Latex protective gloves. First, trim the hoof in a conventional manner. Then, liberally brush the conditioner (which is an acid etch consisting of 37 wt % phosphoric acid, ferric chloride 3 wt %, silica 20 wt % and 40 wt % water) on the trimmed epidermal hoof and horn, i.e., on all areas where shoe is to be cemented. Allow the conditioner to remain about 1 minute. Rinse with copious amounts of clean water. There is no need to dry. Next, using a soft bristle brush, apply a thin coat (about 1 g) of bonding agent (which consists of a mixture of Ig glutaraldehyde, 5.83 g HEMA, and 9.83 g of ethyl alcohol/water (70%/30%)) to this conditioned surface and allow to self dry (about 1 minute).

In cases where the conditioner and bonding agent are applied together, no washing is required. Instead, the acid concentration is reduced so that it will not harm the integrity of the hoof.

In a suitable container (e.g., a waxed paper cup), dispense 6 parts by weight of Part “A” of the two component cement paste composition (which consists of a mixture of 50 g tetrahydrofurfurylmethacrylate (“THFMMA”), 100 g urethane dimethacrylate (“UDMA”), 88 g HEMA, 21 g ethyleneglycol dimethacrylate (“EGDMA”)) into the cup. Then, dispense 5 parts by weight of Part “B” powder (which consists of 25 g polyethylmethylmethacrylate (“(p)EMMA”) clear polymer with 2 wt % benzoyl peroxide (“BPO”)). Add Part “B” to Part “A” and dissolve the polymer. Then, add 104 g. of diatomaceous earth. The diatomaceous earth can be mixed into Part B powder in the appropriate amount. Mix to a paste-like consistency in the cup.

An alternative amount of part B can be used to make a suitable consistency for coating the hoof to receive the horseshoe. Preferably, a consistency like peanut butter is used. Mix the components with a wooden stirrer, such as a tongue blade for about 30-45 seconds or until powder is thoroughly incorporated into the paste. Coat on the hoof and position the shoe. Place any adjusting device such as a shim between the shoe and the hoof. Preferably, the work time for the cement composition is about 90 seconds. The cement composition preferably sets within about 1 minute. Remove excess cement and wipe away any residual tacky surface with an alcohol wipe before setting occurs.

For extended work time, refrigerate the cement paste prior to using. More or less of Part B powder can be used to affect consistency, and work time and set times, as desired.

When using a plastic shoe, it is desirable to abrade hoof contacting surface and wipe clean with ethyl alcohol, isopropyl alcohol, acetone, or the like prior to cementing the shoe to the hoof. Mechanical retention features on the shoe can be used for additional retention in the cement.

Kits containing sufficient conditioner, bonding agent and cement composition for shoeing from 1 to 4 hoofs are contemplated.

The present invention has been described including the preferred embodiments thereof however, upon reading and considering this disclosure, those skilled in the art may make alterations and/or improvements within the spirit and scope of this disclosure.

1. A method for shoeing a hoofed animal, the method comprising: applying an acid conditioner to a hoof for a time sufficient to etch and further expose the inner epidermis layer of the hoof; applying a bonding resin to the hoof; applying a cement composition to the area of the hoof where a shoe will be placed; positioning a shoe in the cement composition; and permitting the cement composition to set, thereby affixing the shoe to the hoof.

2. The method of claim 1, wherein the conditioner comprises ferric chloride.

3. The method of claim 1, wherein the conditioner comprises an acid selected from the group consisting of ethylenediaminetetraacetic acid, malic acid, malaeic acid, glutaric dialdehyde, citric acid, acetic acid, phosphoric acid, nitric acid, sulfuric acid, and mixtures thereof.

4. The method of claim 2, wherein the conditioner comprises ferric chloride.

5. The method of claim 1, wherein the bonding resin comprises a polymerizable or self-drying and hardening, fibril-interpenetrating material.

6. The method of claim 5, wherein the bonding resin comprises a resin forming material selected from the group consisting of acrylate, dimethacrylate, cyanoacrylate, urethane, epoxy and silicone.

7. The method of claim 1, wherein the bonding resin comprises hydroxyethylmethacrylate.

8. The method of claim 1, wherein the cement composition comprises a resin matrix of an organically or inorganically filled two-part curable polymer.

9. The method of claim 8, wherein the cement composition comprises organic or inorganic fillers.

10. The method of claim 8, wherein the cement composition comprises one of more fillers selected from the group consisting of silica, fumed silica, diatomaceous earth, ground glass, zeolite, aluminosilicate, and fractionated organic polymer particles derived from a polymer containing a methacrylic acid monomer.

11. The method of claim 10, wherein the polymer comprises a methyl, ethyl, hydroxyethyl, propyl or butyl methacrylates, and mixtures thereof.

12. The method of claim 1, wherein the cement composition comprises a polymerizable resin and a filler in an amount by weight of from about 10% to about 60% of the total mixture.

13. A kit comprising a package containing sufficient quantities of materials for shoeing 1 to 4 hoofs, the materials comprising a conditioner capable for etching and further exposing the inner epidermis layer of the hoof, a bonding resin and a cement composition.

14. The kit of claim 13, wherein the conditioner comprises an acid selected from the group consisting of ethylenediaminetetraacetic acid, malic acid, malaeic acid, glutaric dialdehyde, citric acid, acetic acid, phosphoric acid, nitric acid, sulfuric acid, and mixtures thereof.

15. The kit of claim 13, wherein the conditioner comprises ferric chloride.

16. The kit of claim 13, wherein the bonding resin comprises a resin forming material selected from the group consisting of acrylate, dimethacrylate, cyanoacrylate, urethane, epoxy and silicone.

17. The kit of claim 13, wherein the bonding resin comprises hydroxyethylmethacrylate.

18. The kit of claim 13, wherein the cement composition comprises a resin matrix of an organically or inorganically filled two-part curable polymer

19. The kit of claim 13, wherein the cement comprises a single part photo-polymerizable resin.

20. The kit of claim 13, wherein the cement composition comprises organic or inorganic fillers.

21. The kit of claim 13, wherein the cement composition comprises one of more fillers selected from the group consisting of silica, fumed silica, diatomaceous earth, ground glass, zeolite, aluminosilicate, and fractionated organic polymer particles derived from a polymer containing a methacrylic acid monomer.

22. The kit of claim 21 wherein the polymer comprises a methyl, ethyl, hydroxyethyl, propyl or butyl methacrylates, and mixtures thereof.

23. The kit of claim 13, wherein the conditioner comprises an acid selected from the group consisting of ethylenediaminetetraacetic acid, malic acid, malaeic acid, glutaric dialdehyde, citric acid, acetic acid, phosphoric acid, nitric acid, sulfuric acid, and mixtures thereof,
wherein the bonding resin comprises a resin forming material selected from the group consisting of acrylate, dimethacrylate, cyanoacrylate, urethane, epoxy and silicone, and
wherein the cement composition comprises a resin matrix of an organically or inorganically filled two-part curable polymer,
wherein the cement composition further comprises one of more fillers selected from the group consisting of silica, fumed silica, diatomaceous earth, ground glass, zeolite, aluminosilicate, and fractionated organic polymer particles derived from a polymer containing a methacrylic acid monomer.

24. The kit of claim 23, wherein the polymer comprises a methyl, ethyl, hydroxyethyl, propyl or butyl methacrylates, and mixtures thereof.
